(19) United States
(12) Patent Application Publication
(10) Pub. No.: US 2014/0066310 A1
(43) Pub. Date: Mar. 6, 2014

(54) METHODS AND SYSTEMS FOR BANANA YIELD PROTECTION AND ENHANCEMENT

(71) Applicant: ROHM AND HAAS COMPANY, Philadelphia, PA (US)

(72) Inventors: Todd Bryan Edgington, Research Triangle Park, NC (US); Timothy Maleyt, Stourdsburg, PA (US); Alvaro R. Urena-Padilla, Cartago (CR)

(73) Assignee: ROHM AND HAAS COMPANY, Philadelphia, PA (US)

(21) Appl. No.: 14/073,487

(22) Filed: Nov. 6, 2013

Related U.S. Application Data
(63) Continuation-in-part of application No. 13/741,537, filed on Jan. 15, 2013.
Application No. 13/741,537 is a continuation of application No. 12/583,406, filed on Aug. 20, 2009, now Pat. No. 8,377,489.
(60) Provisional application No. 61/735,698, filed on Dec. 11, 2012.
(60) Provisional application No. 61/189,995, filed on Aug. 25, 2008.

(51) Int. Cl. A23B 7/154

(52) U.S. Cl. CPC A23B 7/154
USPC 504/357

(57) ABSTRACT

This invention relates to the use of an ethylene synthesis or perception inhibitor for treating stressed or unstressed banana plant or plant parts in the field prior to harvest. Because the pre-mature ripening is triggered by ethylene produced by the plant, such inhibitor can be sprayed or gassed on the fruit while it is in the plantation (on the tree) to protect and avoid the pre-mature ripening of fruit left on for the full growth period of 12-14 weeks (instead of 11 weeks or less). The invention, therefore, enables the banana growers to leave the fruit on the tree for the full growth period (even under certain stress), thereby gaining a yield benefit without the problem of pre-mature ripening in transit.

### CROSS-REFERENCE TO RELATED APPLICATIONS

This application claims priority under 35 U.S.C. §119 of U.S. provisional patent application Ser. No. 61/735,698 filed Dec. 11, 2012, which application is hereby incorporated by reference in its entirety. This application also claims priority as a continuation-in-part of U.S. patent application Ser. No. 13/741,537 filed Jan. 15, 2013, which is a continuation of application Ser. No. 12/583,406 filed Aug. 20, 2009, now U.S. Pat. No. 8,377,489, which claims priority of provisional patent application No. 61/189,995 filed Aug. 25, 2008; the contents of which are hereby incorporated by reference in their entireties.

### BACKGROUND

It is common to harvest and then ship bananas while the peels are green. It is also common, once the bananas have reached a location near where they will be sold, to place them in an enclosed volume and expose them to ethylene gas. After the exposure to ethylene, the normally ripen more quickly. As the bananas ripen, the peels gradually turn yellow; the peels remain yellow for some time; then the peels develop black spots; and eventually the bananas become undesirably over-ripe.

Bananas are prone to various problems. One such problem is premature ripening, which sometimes occurs during shipment. It is desired that the bananas have a green life (i.e., the time during which they remain green) that is longer than the shipping time. Sometimes, events can shorten the green life of bananas. For example, if, during shipment, the interior of a container of bananas is exposed to ethylene gas, many of the bananas will ripen prior to arrival at their destination, and many of those bananas will need to be discarded. This premature ripening causes significant losses to the banana industry.

The problem of premature ripening is exacerbated if the bananas were stressed prior to harvest. Stress can arise from a variety of causes, including, for example, flooding or disease (such as, for example, black Sigatoka) or other stress factors or combinations thereof It is considered that stressed bananas will normally have a shortened green life. Commonly, when stress is observed, the bananas are harvested early, which helps to extend the green life, but the early harvesting causes a reduction in size of the bananas and in crop yield.

Another common problem is that bananas have a relatively short yellow life. That is, while bananas are on display in a retail setting, they are desirable to consumers during their “yellow life” (i.e., from the time the peels start to turn yellow until the bananas become over-ripe). Because the yellow life is often very short, many bananas reach the end of their yellow life before they are sold and have to be discarded, which also causes losses to the banana industry.

Most of the banana companies are often harvesting the banana fruit about a week or 2 earlier than normal if they have stress in the field. The stress can come from too much water during the wet season, too much Sigatoka disease, hot weather and other biological or environmental factors. After harvest, the bananas are in transit for 7-40 days and during that time they must remain green. The stress they are under in the field causes normal age fruit to pre-maturely ripen in transit, which leads to loss of whole shipments of fruit. To combat this, the banana companies harvest the fruit earlier which solves that problem, but results in about a 10% yield loss per week of earlier harvest. Other methods to control in-transit ripening include the use of sealed modified atmosphere packaging (MAP) bags in the box or Controlled Atmospheres in marine containers or break bulk vessels, but their use is cumbersome and costly.

Thus, there remains a need for further development of methods and/or systems for banana yield protection and/or enhancement.

SUMMARY OF INVENTION

The present invention methods and/or systems for banana yield protection and/or increase/enhancement where banana plants are treated with an ethylene synthesis or perception inhibitor before harvest. Such pre-harvest treatment enables the banana fruits to stay in plantation longer before harvest and therefore increases banana yield.

In one aspect, provided is a method of protecting or increasing yield of banana. The method comprises (a) contacting a banana plant before harvest of banana fruit with a composition comprising an ethylene synthesis or perception inhibitor; and (b) harvesting the banana fruit after a predetermined period of time after step (a); thereby protecting or increasing the yield of banana in comparison to a banana plant not contacted with the composition before harvest.

In one embodiment, the yield increase is at least 20%. In another embodiment, the yield increase is at least 40%. In another embodiment, the yield increase is 10%, 15%, 20%, 25%, 30%, 35%, 40$, 45%, 50%, or 60%. In another embodiment, the banana plant is under stress before and/or during treatment of step (a). In a further embodiment, the stress is selected from the group consisting of flood, drought, disease, heat, or cold. In one embodiment, the disease comprises Sigatoka disease.

In one embodiment, the ethylene synthesis or perception inhibitor comprises a cyclopropene compound or an aminovynilglycine. In a further embodiment, the cyclopropene compound is part of a cyclopropene complex. In another embodiment, the cyclopropene complex comprises an inclusion complex. In another embodiment, the cyclopropene complex comprises a cyclopropene and an encapsulation agent. In another embodiment, the encapsulation agent is selected from the group consisting of substituted cyclodextrins, unsubstituted cyclodextrins, crown ethers, zeolites, and combinations thereof. In a further embodiment, the encapsulation agent is a cyclodextrin. In another embodiment, the cyclodextrin is selected from the group consisting of alpha-cyclodextrin, beta-cyclodextrin, gamma-cyclodextrin, and combinations thereof.

In various embodiments, the composition has any of the more particular features described herein below. In one embodiment, the cyclopropene compound is of the formula:

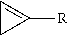

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In another embodiment, R is C₁₋₈ alkyl. In another embodiment, R is methyl.

In another embodiment, the cyclopropene compound is of the formula:

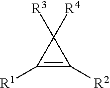

wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen. In still yet another embodiment, the cyclopropene comprises 1-methylcyclopropene (1-MCP).

In one embodiment, the predetermined period of time is at least five days. In another embodiment, the predetermined period of time is one week, two weeks, three weeks, or four weeks.

In another aspect, provided is a method of preserving or extending banana shelf-life or freshness during transit. The methods comprises (a) contacting a banana plant before harvest of banana fruit with a composition comprising an ethylene synthesis or perception inhibitor; and (b) harvesting the banana fruit after a predetermined period of time after step (a); thereby preserving or extending banana shelf-life or freshness during transit in comparison to a banana plant not contacted with the composition before harvest.

In one embodiment, the freshness of banana can be determined based on commercial standard colors for banana fruit. Such typical commercial standard colors include various colors or shades between yellow and green and those skilled in the art would have been familiar with such commercial standard colors.

In one embodiment, the banana shelf-life is extended at least two weeks. In another embodiment, the banana shelf-life is extended ten days, twenty days, thirty days, or forty days. In another embodiment, the banana plant is under stress before or during treatment of step (a). In a further embodiment, the stress is selected from the group consisting of flood, drought, disease, heat, or cold. In one embodiment, the disease comprises Sigatoka disease.

In one embodiment, the ethylene synthesis or perception inhibitor comprises a cyclopropene compound or an aminovynilglycine. In a further embodiment, the cyclopropene compound is part of a cyclopropene complex. In another embodiment, the cyclopropene complex comprises an inclusion complex. In another embodiment, the cyclopropene complex comprises a cyclopropene and an encapsulation agent. In another embodiment, the encapsulation agent is selected from the group consisting of substituted cyclodextrins, unsubstituted cyclodextrins, crown ethers, zeolites, and combinations thereof. In a further embodiment, the encapsulation agent is a cyclodextrin. In another embodiment, the cyclodextrin is selected from the group consisting of alpha-cyclodextrin, beta-cyclodextrin, gamma-cyclodextrin, and combinations thereof.

In various embodiments, the composition has any of the more particular features described herein below. In one embodiment, the cyclopropene compound is of the formula:

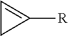

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In another embodiment, R is C₁₋₈ alkyl. In another embodiment, R is methyl.

In another embodiment, the cyclopropene compound is of the formula:

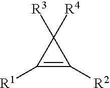

wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen. In still yet another embodiment, the cyclopropene comprises 1-methylcyclopropene (1-MCP).

In one embodiment, the predetermined period of time is at least five days. In another embodiment, the predetermined period of time is one week, two weeks, three weeks, or four weeks. In one embodiment, the banana shelf-life is extended for at least three more days. In another embodiment, the banana shelf-life is extended for one more week, two more weeks, three more weeks, or four more weeks.

In another aspect, provided is a method of extending banana yellow life. The methods comprises (a) contacting a banana plant before harvest of banana fruit with a composition comprising an ethylene synthesis or perception inhibitor; and (b) harvest the banana fruit after a first predetermined period of time after step (a); thereby extending banana yellow life in comparison to a banana plant not contacted with the composition before harvest.

In one embodiment, the method further comprises (c) contacting the harvested banana with ethylene to accelerate banana ripening after a second predetermined period of time after step (b).

In one embodiment, the yellow life of banana can be determined based on commercial standard colors for banana fruit. Such typical commercial standard colors include various colors or shades between yellow and green and those skilled in the art would have been familiar with such commercial standard colors. As used herein, the phrase “yellow life” refers to a period of time for harvested banana with commercially feasible yellow colors. The yellow life is typically from the time the peels start to turn yellow from green until the bananas become over-ripe, for example with brown spots.

In one embodiment, the banana yellow life is extended at least three days. In another embodiment, the banana yellow life is extended at least five days. In another embodiment, the banana yellow life is extended for one week, two weeks, or three weeks. In another embodiment, the banana plant is under stress before or during treatment of step (a). In a further embodiment, the stress is selected from the group consisting of flood, drought, disease, heat, or cold. In one embodiment, the disease comprises Sigatoka disease.

In one embodiment, the ethylene synthesis or perception inhibitor comprises a cyclopropene compound or an aminovynilglycine. In a further embodiment, the cyclopropene compound is part of a cyclopropene complex. In another embodiment, the cyclopropene complex comprises an inclusion complex. In another embodiment, the cyclopropene complex comprises a cyclopropene and an encapsulation agent. In another embodiment, the encapsulation agent is selected from the group consisting of substituted cyclodextrins, unsubstituted cyclodextrins, crown ethers, zeolites, and combinations thereof In a further embodiment, the encapsulation agent is a cyclodextrin. In another embodiment, the cyclodextrin is selected from the group consisting of alpha-cyclodextrin, beta-cyclodextrin, gamma-cyclodextrin, and combinations thereof.

In various embodiments, the composition has any of the more particular features described herein below. In one embodiment, the cyclopropene compound is of the formula:

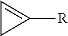

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In another embodiment, R is C₁₋₈ alkyl. In another embodiment, R is methyl.

In another embodiment, the cyclopropene compound is of the formula:

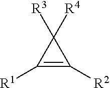

wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen. In still yet another embodiment, the cyclopropene comprises 1-methylcyclopropene (1-MCP).

In one embodiment, the first predetermined period of time is at least five days. In another embodiment, the first predetermined period of time is one week, two weeks, three weeks, or four weeks. In one embodiment, the second predetermined period of time is at least two days. In another embodiment, the second predetermined period of time is one week, two weeks, three weeks, or four weeks. In one embodiment, the banana yellow life is extended for at least three more days. In another embodiment, the banana yellow life is extended for one more week, two more weeks, three more weeks, or four more weeks.

In various embodiments of aspects disclosed herein, the phrase “contacting” or “contact” include different ways of applying volatile compound such as 1-MCP. In some embodiments of aspects disclosed herein, the contacting step comprises spraying, dipping, gassing, and/or fogging. In one embodiment, the contacting step comprises spraying or gassing.

### BRIEF DESCRIPTION OF THE DRAWINGS

FIG. 1 shows a representative experimental design for treatments used in the example disclosed herein.

FIG. 2 shows representative banana fruit weight increase from 11 weeks to 12 weeks where 1-MCP allows the delay of harvest by at least one week. This additional week may provide a 28% increase in yield of each bunch harvested, which may result in 700 boxes more fruit/hectare.

FIG. 3 shows a representative color evolution of fruits treated with 1-MCP and untreated controls, where 1-MCP clearly delays color development. Pre-harvest 1-MCP treatment can be useful for improved shelf life and for prevention of ripening during transit.

FIG. 4 shows a representative comparison of fruit color treated with 1-MCP and untreated after 21 days transport simulation, where untreated checks begin to show some signs of pre-mature ripening after removal from simulated transit.

FIG. 5 shows a representative comparison of fruit color treated with 1-MCP and untreated 6 days after ripening induction, where 1-MCP clearly delays color development. 1-MCP has effects on both transit and shelf life.

FIG. 6 shows a representative comparison of percentage of sugar (brix) on fruit evaluated 6 days after ripening induction, where 1-MCP clearly delays sugar spot development. Sugar spotted bananas are not desired for retail. Thus, the inplantation use of 1-MCP may have a post harvest benefit at the retail level.

### DETAILED DESCRIPTION OF THE INVENTION

This invention relates to the use of 1-MCP for treating stressed or unstressed banana plant or plant parts in the field prior to harvest. Because the pre-mature ripening is triggered by ethylene produced by the plant, 1-MCP can be sprayed or gassed on the fruit while it is in the plantation (on the tree) to protect and avoid the pre-mature ripening of fruit left on for the full growth period of 12-14 weeks (instead of 11 weeks or less). The invention, therefore, enables the banana growers to leave the fruit on the tree for the full growth period (even under certain stress), thereby gaining a yield benefit without the problem of pre-mature ripening in transit.

1-MCP is known for the use to delay or slow the ripening process of bananas harvested at full maturity (i.e., post-harvest applications). The invention provides that 1-MCP can be used to delay pre-harvest banana premature ripening, and such pre-harvest application of 1-MCP can extend transit and shelf life of banana.

As used herein, “banana” refers to any member of the genus Musa, including, for example, bananas and plantains.

As used herein, when bananas are said to be “treated,” it is meant that the bananas are brought into contact with the liquid composition of the present invention.

The practice of the present invention involves the use of one or more cyclopropene compound. As used herein, a cyclopropene compound is any compound with the formula

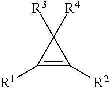

where each R¹, R², R³ and R⁴ is independently selected from the group consisting of H and a chemical group of the formula:

-(L)ₙ-Z

where n is an integer from 0 to 12. Each L is a bivalent radical. Suitable L groups include, for example, radicals containing one or more atoms selected from H, B, C, N, O, P, S, Si, or mixtures thereof. The atoms within an L group may be connected to each other by single bonds, double bonds, triple bonds, or mixtures thereof. Each L group may be linear, branched, cyclic, or a combination thereof In any one R group (i.e., any one of R¹, R², R³ and R⁴) the total number of heteroatoms (i.e., atoms that are neither H nor C) is from 0 to 6. Independently, in any one R group the total number of non-hydrogen atoms is 50 or less. Each Z is a monovalent radical. Each Z is independently selected from the group consisting of hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

The R¹, R², R³, and R⁴ groups are independently selected from the suitable groups. Among the groups that are suitable for use as one or more of R¹, R², R³, and R⁴ are, for example, aliphatic groups, aliphatic-oxy groups, alkylphosphonato groups, cycloaliphatic groups, cycloalkylsulfonyl groups, cycloalkylamino groups, heterocyclic groups, aryl groups, heteroaryl groups, halogens, silyl groups, other groups, and mixtures and combinations thereof. Groups that are suitable for use as one or more of R¹, R², R³, and R⁴ may be substituted or unsubstituted.

Among the suitable R¹, R², R³, and R⁴ groups are, for example, aliphatic groups. Some suitable aliphatic groups include, for example, alkyl, alkenyl, and alkynyl groups. Suitable aliphatic groups may be linear, branched, cyclic, or a combination thereof. Independently, suitable aliphatic groups may be substituted or unsubstituted.

As used herein, a chemical group of interest is said to be “substituted” if one or more hydrogen atoms of the chemical group of interest is replaced by a substituent.

Also among the suitable R¹, R², R³, and R⁴ groups are, for example, substituted and unsubstituted heterocyclyl groups that are connected to the cyclopropene compound through an intervening oxy group, amino group, carbonyl group, or sulfonyl group; examples of such R¹, R², R³, and R⁴ groups are heterocyclyloxy, heterocyclylcarbonyl, diheterocyclylamino, and diheterocyclylaminosulfonyl.

Also among the suitable R¹, R², R³, and R⁴ groups are, for example, substituted and unsubstituted heterocyclic groups that are connected to the cyclopropene compound through an intervening oxy group, amino group, carbonyl group, sulfonyl group, thioalkyl group, or aminosulfonyl group; examples of such R¹, R², R³, and R⁴ groups are diheteroarylamino, heteroarylthioalkyl, and diheteroarylaminosulfonyl.

Also among the suitable R¹, R², R³, and R⁴ groups are, for example, hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl, butylmercapto, diethylphosphonato, dimethylphenylsilyl, isoquinolyl, mercapto, naphthyl, phenoxy, phenyl, piperidino, pyridyl, quinolyl, triethylsilyl, trimethylsilyl; and substituted analogs thereof.

As used herein, the chemical group G is a 3 to 14 membered ring system. Ring systems suitable as chemical group G may be substituted or unsubstituted; they may be aromatic (including, for example, phenyl and napthyl) or aliphatic (including unsaturated aliphatic, partially saturated aliphatic, or saturated aliphatic); and they may be carbocyclic or heterocyclic. Among heterocyclic G groups, some suitable heteroatoms are, for example, nitrogen, sulfur, oxygen, and combinations thereof Ring systems suitable as chemical group G may be monocyclic, bicyclic, tricyclic, polycyclic, spiro, or fused; among suitable chemical group G ring systems that are bicyclic, tricyclic, or fused, the various rings in a single chemical group G may be all the same type or may be of two or more types (for example, an aromatic ring may be fused with an aliphatic ring).

In one embodiment, one or more of R¹, R², R³, and R⁴ is hydrogen or (C₁-C₁₀) alkyl. In another embodiment, each of R¹, R², R³, and R⁴ is hydrogen or (C₁-C₈) alkyl. In another embodiment, each of R¹, R², R³, and R⁴ is hydrogen or (C₁-C₄) alkyl. In another embodiment, each of R¹, R², R³, and R⁴ is hydrogen or methyl. In another embodiment, R¹ is (C₁-C₄) alkyl and each of R², R³, and R⁴ is hydrogen. In another embodiment, R¹ is methyl and each of R², R³, and R⁴ is hydrogen, and the cyclopropene compound is known herein as 1-methylcyclopropene or “1-MCP.”

In one embodiment, a cyclopropene compound can be used that has boiling point at one atmosphere pressure of 50° C. or lower; 25° C. or lower; or 15° C. or lower. In another embodiment, a cyclopropene compound can be used that has boiling point at one atmosphere pressure of −100° C. or higher; −50° C. or higher; −25° C. or higher; or 0° C. or higher.

The cyclopropenes applicable to this invention may be prepared by any method. Some suitable methods of preparation of cyclopropenes are the processes disclosed in U.S. Pat. Nos. 5,518,988 and 6,017,849.

The composition of the present invention may include at least one molecular encapsulating agent. Suitable molecular encapsulating agents include, for example, organic and inorganic molecular encapsulating agents. Suitable organic molecular encapsulating agents include, for example, substituted cyclodextrins, unsubstituted cyclodextrins, and crown ethers. Suitable inorganic molecular encapsulating agents include, for example, zeolites. Mixtures of suitable molecular encapsulating agents are also suitable. In some embodiments of the invention, the encapsulating agent is alpha-cyclodextrin, beta-cyclodextrin, gamma-cyclodextrin, or a mixture thereof. In some embodiments of the invention, particularly when the cyclopropene is 1-methylcyclopropene, the encapsulating agent is alpha-cyclodextrin. The preferred encapsulating agent will vary depending upon the structure of the cyclopropene or cyclopropenes being used. Any cyclodextrin or mixture of cyclodextrins, cyclodextrin polymers, modified cyclodextrins, or mixtures thereof can also be utilized pursuant to the present invention. Some cyclodextrins are available, for example, from Wacker Biochem Inc., Adrian, Mich., as well as other vendors.

At least one molecular encapsulating agent encapsulates one or more cyclopropenes. A cyclopropene or substituted cyclopropene molecule encapsulated in a molecule of a molecular encapsulating agent is known herein as a “cyclopropene molecular encapsulating agent complex.” The cyclopropene molecular encapsulation agent complexes can be prepared by any means. In one method of preparation, for example, such complexes are prepared by contacting the cyclopropene with a solution or slurry of the molecular encapsulation agent and then isolating the complex, using, for example, processes disclosed in U.S. Pat. No. 6,017,849. For example, in one method of making a complex in which 1-MCP is encapsulated in a molecular encapsulating agent, the 1-MCP gas is bubbled through a solution of alpha-cyclodextrin in water, from which the complex first precipitates and is then isolated by filtration. In some embodiments, complexes are made by the above method and, after isolation, are dried and stored in solid form, for example as a powder, for later addition to useful compositions.

In one embodiment, at least one cyclopropene compound complex is present that is an inclusion complex. In a further embodiment for such an inclusion complex, the molecular encapsulating agent forms a cavity, and the cyclopropene compound or a portion of the cyclopropene compound is located within that cavity.

In another embodiment for such inclusion complexes, the interior of the cavity of the molecular encapsulating agent is substantially apolar or hydrophobic or both, and the cyclopropene compound (or the portion of the cyclopropene compound located within that cavity) is also substantially apolar or hydrophobic or both. While the present invention is not limited to any particular theory or mechanism, it is contemplated that, in such apolar cyclopropene compound complexes, van der Waals forces, or hydrophobic interactions, or both, cause the cyclopropene compound molecule or portion thereof to remain within the cavity of the molecular encapsulating agent.

The amount of molecular encapsulating agent can usefully be characterized by the ratio of moles of molecular encapsulating agent to moles of cyclopropene compound. In one embodiment, the ratio of moles of molecular encapsulating agent to moles of cyclopropene compound can be 0.1 or larger; 0.2 or larger; 0.5 or larger; or 0.9 or larger. In another embodiment, the ratio of moles of molecular encapsulating agent to moles of cyclopropene compound can be 10 or lower; 5 or lower; 2 or lower; or 1.5 or lower.

Suitable molecular encapsulating agents include, for example, organic and inorganic molecular encapsulating agents. Suitable organic molecular encapsulating agents include, for example, substituted cyclodextrins, unsubstituted cyclodextrins, and crown ethers. Suitable inorganic molecular encapsulating agents include, for example, zeolites. Mixtures of suitable molecular encapsulating agents are also suitable. In one embodiment, the encapsulating agent comprises alpha-cyclodextrin, beta-cyclodextrin, gamma-cyclodextrin, or combinations thereof. In a further embodiment, the encapsulating agent comprises alpha-cyclodextrin.

The practice of the present invention may involve one or more liquid compositions. Liquid compositions are liquid at 25° C. In some embodiments, liquid compositions are liquid at the temperature at which the composition is used to treat bananas. Because bananas are often treated outside of any buildings or in buildings that are not temperature-controlled, bananas may be treated at temperatures ranging from 1° C. to 45° C.; suitable liquid compositions need not be liquid over that entire range, but suitable liquid compositions are liquid at least at some temperature from 1° C. to 45° C.

If a liquid composition contains more than one substance, that liquid composition may be a solution or a dispersion or a combination thereof. If, in the liquid composition, one substance is dispersed in another substance in the form of a dispersion, the dispersion may be of any type, including, for example, a slurry, a suspension, a latex, an emulsion, a miniemulsion, a microemulsion, or any combination thereof.

In some embodiments, the amount of cyclopropene in the liquid composition may be 0.1 microgram per liter or more; or 0.2 microgram per liter or more; or 0.5 microgram per liter or more; or 1 microgram per liter or more; or 2 microgram per liter or more; or 4 microgram per liter or more. Independently, in some embodiments, the amount of cyclopropene in the liquid composition is 1,000 microgram per liter or less; or 500 microgram per liter or less; or 200 microgram per liter or less; or 100 microgram per liter or less.

In some embodiments, the composition of the present invention includes no metal chelating agents. In some embodiments, one or more compositions of the present invention may include one or more metal chelating agents.

A metal chelating agent is a compound, each molecule of which is capable of forming two or more coordinate bonds with a single metal atom. Some metal chelating agents form coordinate bonds with metal atoms because the metal chelating agents contain electron-donor atoms that participate in coordinate bonds with metal atoms. Suitable chelating agents include, for example, organic and inorganic chelating agents. Among the suitable inorganic chelating agents are, for example, phosphates such as, for example, tetrasodium pyrophosphate, sodium tripolyphosphate, and hexametaphosphoric acid. Among the suitable organic chelating agents are those with macrocyclic structures and non-macrocyclic structures. Among the suitable macrocyclic organic chelating agents are, for example, porphine compounds, cyclic polyethers (also called crown ethers), and macrocyclic compounds with both nitrogen and oxygen atoms.

Some suitable organic chelating agents that have non-macrocyclic structures are, for example, aminocarboxylic acids, 1,3-diketones, hydroxycarboxylic acids, polyamines, aminoalcohols, aromatic heterocyclic bases, phenol, aminophenols, oximes, Shiff bases, sulfur compounds, and mixtures thereof. In some embodiments, the chelating agent includes one or more aminocarboxylic acids, one or more hydroxycarboxylic acids, one or more oximes, or a mixture thereof. Some suitable aminocarboxylic acids include, for example, ethylenediaminetetraacetic acid (EDTA), hydroxyethylethylenediaminetriacetic acid (HEDTA), nitrilotriacetic acid (NTA), N-dihydroxyethylglycine (2-HxG), ethylenebis(hydroxyphenylglycine) (EHPG), and mixtures thereof. Some suitable hydroxycarboxylic acids include, for example, tartaric acid, citric acid, gluconic acid, 5-sulfoslicylic acid, and mixtures thereof. Some suitable oximes include, for example, dimethylglyoxime, salicylaldoxime, and mixtures thereof. In some embodiments, EDTA is used.

Among embodiments in which a chelating agent is used that is an acid, the acid may be present in neutral form or in the form of a salt or in a combination thereof. Salts may have any counterion, including, for example, sodium, potassium, magnesium, calcium, or mixtures thereof. In some embodiments, magnesium or calcium or a mixture thereof is used.

Some additional suitable chelating agents are polymeric. Some suitable polymeric chelating agents include, for example, polyethyleneimines, polymethacryloylacetones, poly(acrylic acid), and poly(methacrylic acid). Poly(acrylic acid) is used in some embodiments. Mixtures of suitable metal-complexing agents are also suitable.

Independently, in some embodiments in which a liquid composition that includes water is used, and in which the liquid composition contains one or more metal-complexing agent, the amount of metal-complexing agent can usefully be characterized by the molar concentration of metal-complexing agent in the liquid composition (i.e., moles of metal-complexing agent per liter of liquid composition). In some of such liquid compositions, the concentration of metal-complexing agent is 0.00001 mM (i.e., milli-Molar) or greater; or 0.0001 mM or greater; or 0.001 mM or greater; or 0.01 mM or greater; or 0.1 mM or greater. Independently, in some embodiments in which a liquid composition of the present invention includes water, the concentration of metal-complexing agent is 100 mM or less; or 10 mM or less; or 1 mM or less.

In some embodiments, the liquid composition of the present invention is aqueous. As used herein, a composition is aqueous if it contains 50% or more water by weight based on the weight of the composition. In some embodiments, the liquid composition of the present invention contains water in the amount, by weight based on the weight of the composition, 75% or more; or 85% or more; or 95% or more.

In some embodiments, the composition of the present invention contains little or no nonionic surfactant. That is, the composition either contains no nonionic surfactant, or, if any nonionic surfactant is present, the amount of nonionic surfactant is, by weight based on the weight of the composition, 0.1% or less; or 0.01% or less; or 0.002% or less. Nonionic surfactants include, for example, alkyl polyoxyalkylene nonionic surfactants, aryl polyoxyalkylene nonionic surfactants, and polyoxyalkylene block copolymer nonionic surfactants.

In some embodiments, the composition of the present invention contains little or no surfactant of any type (i.e., nonionic, anionic, or cationic).

In some embodiments, one or more oils may be used in certain liquid formulation As used herein, an “oil” refers to a compound that is liquid at 25° C. and 1 atmosphere pressure and that has a boiling point at 1 atmosphere pressure of 30° C. or higher. As used herein, “oil” does not include water, does not include surfactants, and does not include dispersants.

In some embodiments, one or more oil may be used that has boiling point of 50° C. or higher; or 75° C. or higher; or 100° C. or higher. In some embodiments, every oil that is used has boiling point of 50° C. or higher. In some embodiments, every oil that is used has boiling point of 75° C. or higher. In some embodiments, every oil that is used has boiling point of 100° C. or higher. Independently, in some of the embodiments that use oil, one or more oil may be used that has an average molecular weight of 100 or higher; or 200 or higher; or 500 or higher. In some embodiments, every oil that is used has average molecular weight of 100 or higher. In some embodiments, every oil that is used has average molecular weight of 200 or higher. In some embodiments, every oil that is used has average molecular weight of 500 or higher.

An oil may be either a hydrocarbon oil (i.e., an oil whose molecule contains only atoms of carbon and hydrogen) or a non-hydrocarbon oil (i.e., an oil whose molecule contains at least at least one atom that is neither carbon nor hydrogen).

Some suitable hydrocarbon oils are, for example, straight, branched, or cyclic alkane compounds with 6 or more carbon atoms. Some other suitable hydrocarbon oils, for example, have one or more carbon-carbon double bond, one or more carbon-carbon triple bond, or one or more aromatic ring, possibly in combination with each other and/or in combination with one or more alkane group. Some suitable hydrocarbon oils are obtained from petroleum distillation and contain a mixture of compounds, along with, in some cases, impurities. Hydrocarbon oils obtained from petroleum distillation may contain a relatively wide mixture of compositions or may contain relatively pure compositions. In some embodiments, hydrocarbon oils are used that contain 6 or more carbon atoms. In some embodiments, hydrocarbon oils are used that contain 18 or fewer carbon atoms. In some embodiments, every hydrocarbon oil that is used contains 18 or fewer carbon atoms. In some embodiments, every hydrocarbon oil that is used contains 6 or more carbon atoms. Some suitable hydrocarbon oils include, for example, hexane, decane, dodecane, hexadecane, diesel oil, refined paraffinic oil (e.g., Ultrafine™ spray oil from Sun Company), and mixtures thereof. In some embodiments, every oil that is used is a hydrocarbon oil.

Among embodiments that use non-hydrocarbon oil, some suitable non-hydrocarbon oils are, for example, fatty non-hydrocarbon oils. “Fatty” means herein any compound that contains one or more residues of fatty acids. Fatty acids are long-chain carboxylic acids, with chain length of at least 4 carbon atoms. Typical fatty acids have chain length of 4 to 18 carbon atoms, though some have longer chains. Linear, branched, or cyclic aliphatic groups may be attached to the long chain. Fatty acid residues may be saturated or unsaturated, and they may contain functional groups, including for example alkyl groups, epoxide groups, halogens, sulfonate groups, or hydroxyl groups that are either naturally occurring or that have been added. Some suitable fatty non-hydrocarbon oils are, for example, fatty acids; esters of fatty acids; amides of fatty acids; dimers, trimers, oligomers, or polymers thereof; and mixtures thereof.

Some of the suitable fatty non-hydrocarbon oils, are, for example, esters of fatty acids. Such esters include, for example, glycerides of fatty acids. Glycerides are esters of fatty acids with glycerol, and they may be mono-, di-, or triglycerides. A variety of triglycerides are found in nature. Most of the naturally occurring triglycerides contain residues of fatty acids of several different lengths and/or compositions. Some suitable triglycerides are found in animal sources such as, for example, dairy products, animal fats, or fish. Further examples of suitable triglycerides are oils found in plants, such as, for example, coconut, palm, cottonseed, olive, tall, peanut, safflower, sunflower, corn, soybean, linseed, tung, castor, canola, citrus seed, cocoa, oat, palm, palm kernel, rice bran, cuphea, or rapeseed oil.

Among the suitable triglycerides, independent of where they are found, are those, for example, that contain at least one fatty acid residue that has 14 or more carbon atoms. Some suitable triglycerides have fatty acid residues that contain 50% or more by weight, based on the weight of the residues, fatty acid residues with 14 or more carbon atoms, or 16 or more carbon atoms, or 18 or more carbon atoms. One example of a suitable triglyceride is soybean oil.

Suitable fatty non-hydrocarbon oils may be synthetic or natural or modifications of natural oils or a combination or mixture thereof Among suitable modifications of natural oils are, for example, alkylation, hydrogenation, hydroxylation, alkyl hydroxylation, alcoholysis, hydrolysis, epoxidation, halogenation, sulfonation, oxidation, polymerization, and combinations thereof. In some embodiments, alkylated (including, for example, methylated and ethylated) oils are used. One suitable modified natural oil is methylated soybean oil.

Also among the suitable fatty non-hydrocarbon oils are self-emulsifying esters of fatty acids.

Another group of suitable non-hydrocarbon oils is the group of silicone oils. Silicone oil is an oligomer or polymer that has a backbone that is partially or fully made up of —Si—O— links. Silicone oils include, for example, polydimethylsiloxane oils. Polydimethylsiloxane oils are oligomers or polymers that contain units of the form

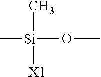

where at least one of the units has X1=CH₃. In other units, X1 may be any other group capable of attaching to Si, including, for example, hydrogen, hydroxyl, alkyl, alkoxy, hydroxyalkyl, hydroxyalkoxy, alkylpolyalkoxyl, substituted versions thereof, or combinations thereof. Substituents may include, for example, hydroxyl, alkoxyl, polyethoxyl, ether linkages, ester linkages, amide linkages, other substituents, or any combination thereof. In some embodiments, every oil that is used is a silicone oil.

In some suitable polydimethylsiloxane oils, all X1 groups are groups that are not hydrophilic. In some suitable polydimethylsiloxane oils, all X1 groups are alkyl groups. In some suitable polydimethylsiloxane oils, all X1 groups are methyl. In some embodiments, every silicone oil is a polydimethylsiloxane oil in which all X1 groups are methyl. In some suitable polydimethylsiloxanes, at least one unit has an X1 group that is not methyl; if more than one non-methyl X1 unit is present, the non-methyl X1 units may be the same as each other, or two or more different non-methyl X1 units may be present. Polydimethylsiloxane oils may be end-capped with any of a wide variety of chemical groups, including, for example, hydrogen, methyl, other alkyl, or any combination thereof. Also contemplated are cyclic polydimethylsiloxane oils. Mixtures of suitable oils are also suitable.

Plants or plant parts may be treated in the practice of the present invention. One example is treatment of whole plants; another example is treatment of whole plants while they are planted in soil, prior to the harvesting of useful plant parts. An example of plant parts includes fruit of banana.

Any plants that provide useful plant parts may be treated in the practice of the present invention, for example fruit of banana.

The bananas treated in the practice of the present invention may be any members of the genus Musa. In some embodiments of the present invention edible fruits of the genus Musa are treated. In some embodiments, plantains or bananas that are not plantains are treated. In some embodiments, bananas that are not plantains are treated. In some embodiments, bananas of the species M. acuminata Colla or the hybrid M. X paradisiaca L. are treated. In some embodiments, members of one or more of the following varieties of banana are treated: Sucrier, Lady Finger, Gros Michel, Cavendish (including, for example, Dwarf Cavendish, Giant Cavendish, Pisang masak hijau, Robusta, or Valery), Bluggoe, Ice Cream, Mysore, Salembale, Rasabale, Pachabale, Chandrabale, Silk, Red, Fehi, Golden Beauty, or Orinoco. In some embodiments, one or more variety of plantains is treated, including, for example, French plantain, Horn plantain, Maaricongo, Common Dwarf, Pelipita, Saba, Harton, Dominico-Harton, or Currare.

Bananas are normally harvested by cutting the bunch of bananas from the pseudostem on which it grew. Subsequent to harvest, bunches are often broken down into smaller connected groups called hands.

In some embodiments, bananas may be brought into contact with the liquid composition by any method. For example, bananas may be brought into contact with the liquid composition by dipping, drenching, brush-applying, spraying (for liquid formulations), gassing (for example sachets or material emitting 1-MCP like a coated strip of paper or polymer), or a combination thereof. In some embodiments, contact is performed by dipping. When dipping is used, bananas are submerged in the liquid composition deeply enough to cover the fruit portion. In a dipping operation, bananas remain submerged for at least 1 second; or at least 2 seconds; or at least 5 seconds; or at least 10 seconds. Independently, in some embodiments employing a dipping operation, bananas remain submerged for 5 minutes or less; or 4 minutes or less; or 2 minutes or less.

In some embodiments, bananas are treated that were exposed to stress prior to harvest. In some cases, stress is caused by, for example, flooding or disease. In some of such embodiments, it is contemplated to harvest the stressed bananas at the growth stage at which they would normally have been harvested if they had not been stressed and to treat the stressed bananas according to the methods of the present invention. Independently, it is contemplated in some embodiments involving stressed bananas, to treat the stressed bananas using liquid composition with concentration of cyclopropene of 35 microgram per liter to 100 microgram per liter.

In some embodiments in which the bananas are not stressed, bananas are contacted with liquid composition having concentration of cyclopropene of less than 35 microgram per liter. In some embodiments in which bananas have been stressed, bananas are contacted with liquid composition having concentration of cyclopropene of more than 35 microgram per liter.

It is to be understood that for purposes of the present specification and claims that the range and ratio limits recited herein can be combined. For example, if ranges of 60 to 120 and 80 to 110 are recited for a particular parameter, it is understood that the ranges of 60 to 110 and 80 to 120 are also contemplated. As a further, independent, example, if a particular parameter is disclosed to have suitable minima of 1, 2, and 3, and if that parameter is disclosed to have suitable maxima of 9 and 10, then all the following ranges are contemplated: 1 to 9, 1 to 10, 2 to 9, 2 to 10, 3 to 9, and 3 to 10.

In another aspect, provided is a method for treating bananas comprising contacting said bananas with a composition comprising a cyclopropene compound/molecular encapsulation agent complex, wherein the duration of said contacting is from 1 second to 4 minutes.

In one embodiment, the liquid composition is aqueous. In another embodiment, the liquid composition comprises from 0% to 0.1% nonionic surfactant by weight based on the total weight of the liquid composition. In another embodiment, the liquid composition contains a metal chelating agent at concentration from 0.1 to 100 millimole per liter. In another embodiment, the contacting is performed by dipping the bananas in the liquid composition. In another embodiment, the dipping has duration of 5 to 60 seconds. In another embodiment, an amount of the cyclopropene compound in the liquid composition is from 5 to 100 microgram per liter.

In one embodiment, the cyclopropene compound is of the formula:

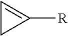

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In another embodiment, R is C₁₋₈ alkyl. In another embodiment, R is methyl.

In another embodiment, the cyclopropene compound is of the formula:

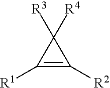

wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen. In still yet another embodiment, the cyclopropene comprises 1-methylcyclopropene (1-MCP).

It is to be understood that for purposes of the present specification and claims that each operation disclosed herein is performed at 25 degree C. unless otherwise specified.

### EXAMPLES

### Example 1

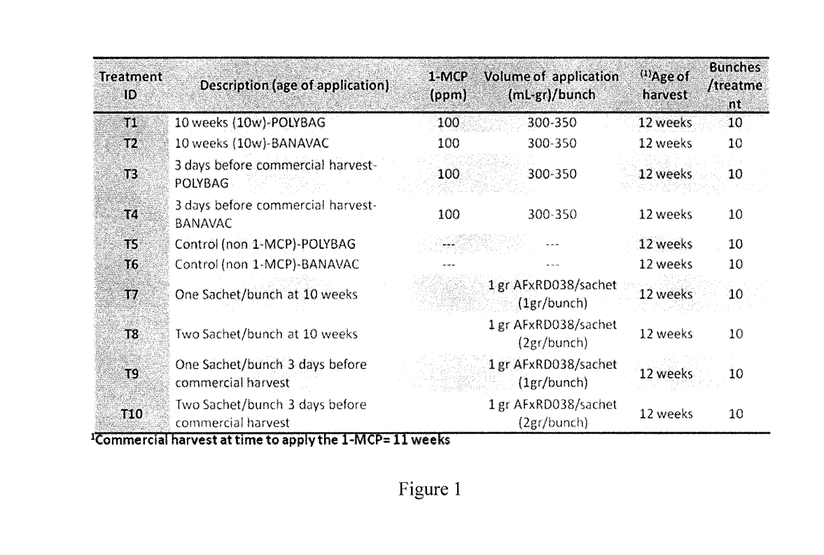

The use of 1-MCP in pre-harvest will help to increase more days of fruit in the field, avoiding natural ripening as well during transport. This aspect will increase significantly the farm productivity and profitability. The objective is to extend hanging time of banana bunch, increasing weight, avoiding natural ripening. Experimental design of 1-MCP treatments is shown in FIG. 1. Other conditions are listed below.
Crop: Musa spp (commercial bananas)
Experimental design: CRD, 10 replications, LSD (5%)
Spray Volume: 300-350 mL/bunch
Quantity per sachet: 1 gr/sachet (1 and 2 sachets per bunch)
Equipment: Hand Spray System and Sachets
Target: Banana bunch
Variables: Green life, maturity homogeneity
Location: Estrella farm, Siquirres, Limon, cable 04
Applications: One/treatment
Trial Period: May 5 to July 13
Trial start=week 22
Trial harvest=week 24
Commercial harvest=11 weeks
Trial harvest=12 weeks

1-MCP: The application of 1-MCP is direct to the bunch using a hand spray system, 300-350 mL/bunch. Experimental application methodology of 1-MCP was using one sachet and two sachet/bunch, 1 gr of a liquid formulation comprising 1-MCP/sachet. After application, each treatment is reviewed for phyto evaluations.

Harvest: Each treatment fruit is then harvested when ready to record weight, number of hands, firmness and grade parameters. All harvested fruit is packed under commercial condition, using EU Polybag bags. Some treatments are packed using EU Banavac bags as well.

Storage: Banana fruits are stored at 14° C. (or 57.2° F.) and 90% RH for 21 days simulating transport to Europe. During storage period, fruits are inspected once a week to evaluate green life.

Evaluation: After transport simulation, banana fruits are ripened using a Catalityc Generator in a ripening cycle of 6 days. Once control fruit reached color 5, all fruit are evaluated for firmness, brix and color.

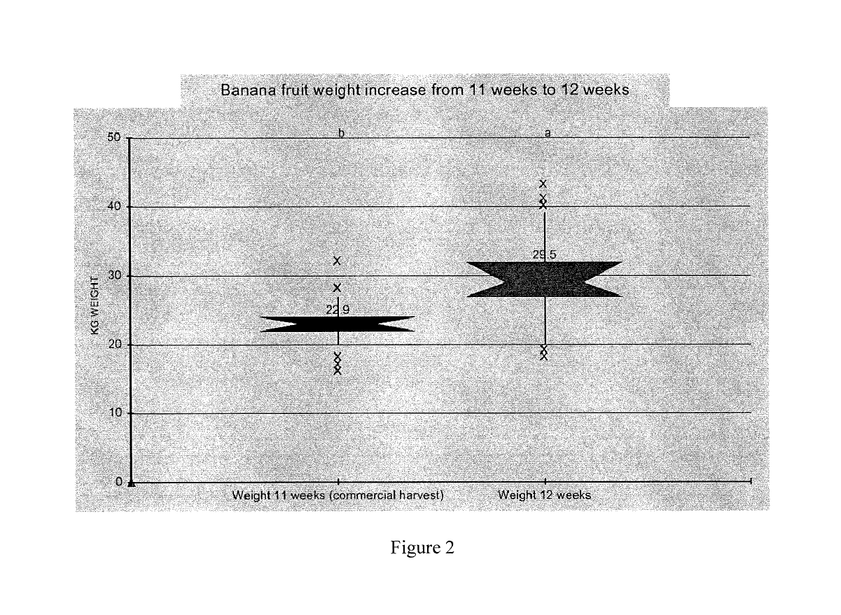

A representative banana fruit weight increase from 11 weeks to 12 weeks is shown in FIG. 2, where 1-MCP allows the delay of harvest by at least one week. This additional week may provide a 28% increase in yield of each bunch harvested, which may result in 700 boxes more fruit/hectare.

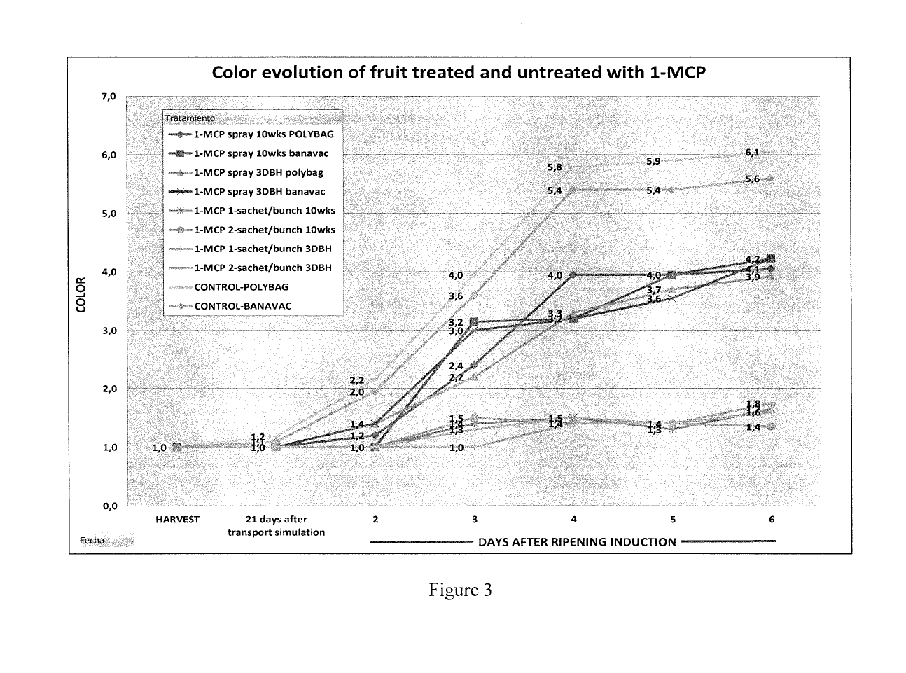

A representative color evolution of fruits treated with 1-MCP and untreated controls is shown in FIG. 3, where 1-MCP clearly delays color development. Pre-harvest 1-MCP treatment can be useful for improved shelf life and for prevention of ripening during transit.

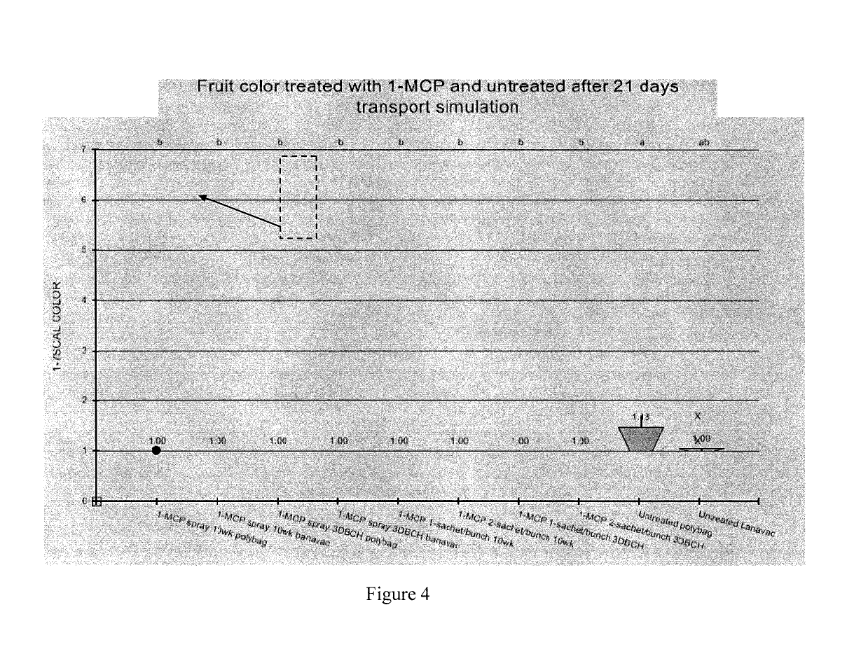

A representative comparison of fruit color treated with 1-MCP and untreated after 21 days transport simulation is shown in FIG. 4, where untreated checks begin to show some signs of pre-mature ripening after removal from simulated transit.

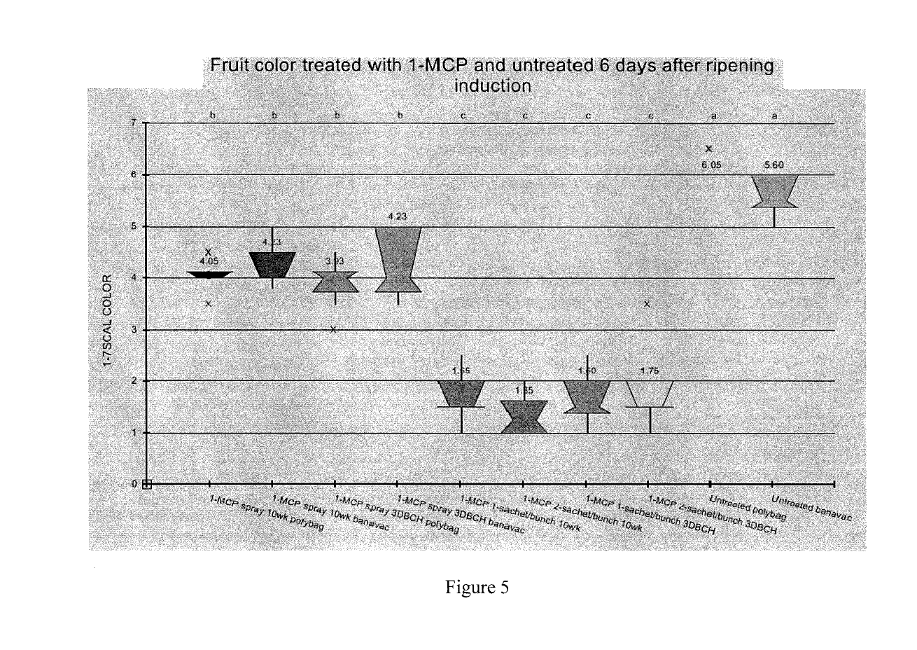

A representative comparison of fruit color treated with 1-MCP and untreated 6 days after ripening induction is shown in FIG. 5, where 1-MCP clearly delays color development. 1-MCP has effects on both transit and shelf life.

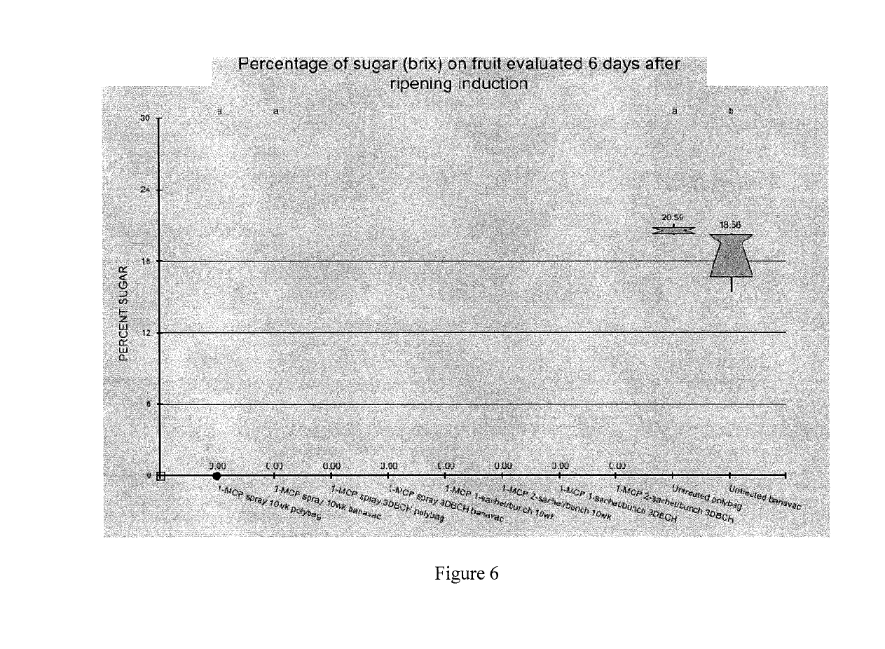

A representative comparison of percentage of sugar (brix) on fruit evaluated 6 days after ripening induction is shown in FIG. 6, where 1-MCP clearly delays sugar spot development. Sugar spotted bananas are not desired for retail. Thus, the inplantation use of 1-MCP may have a post harvest benefit at the retail level.

The age of commercial harvest may depend on the time of the year (growth). For this example, the harvest time is changed from 11 weeks to 10 weeks, due the excellent environmental conditions. Banana fruits typically are not left in the field for more than two weeks, because the risk of fruit burst is high after certain period of time.

Sachet release container for 1-MCP application works very well in this example, where no pre-harvest ripening or uneven ripening have been observed. No statistical differences have been observed between one or two sachets in this example. Sachet application can increase worker productivity as compared to spray applications of 1-MCP.

Spray applications of 1-MCP works well in this example, but worker productivity is lower than sachet release container. In this example, one more week hanging the fruit in the field gave 6.6 kg of weight gain (700 more boxes/ha/year). This corresponds to greater than a 20% yield increase.

1-MCP is effective to prevent natural ripening of banana fruit harvested later than commercial harvest. The use of sachets to apply 1-MCP shows good results from the point of view of application technique. In terms of commercial process, one field worker can put between 12 to 15 ha/day. After ethylene application, 1-MCP application can delay color fruit evolution compared to untreated. In this example, there are no statistical differences between 1 gr or 2 gr/sachet/bunch. Maturity homogeneity, firmness and brix are not affected by 1-MCP application.

We claim:

1. A method of protecting or increasing yield of banana, comprising:
(a) contacting a banana plant before harvest of banana fruit with a composition comprising an ethylene synthesis or perception inhibitor; and
(b) harvesting the banana fruit after a predetermined period of time after step (a);
thereby protecting or increasing the yield of banana in comparison to a banana plant not contacted with the composition before harvest.

2. The method of claim 1, wherein the yield increase is at least 20%.

3. The method of claim 1, wherein the banana plant is under stress before or during treatment of step (a).

4. The method of claim 1, wherein the ethylene synthesis or perception inhibitor comprises a cyclopropene compound or an aminovynilglycine.

5. The method according to claim 4, wherein the cyclopropene compound is of the formula: 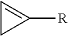
wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

6. The method of claim 5, wherein R is C₁₋₈ alkyl.

7. The method of claim 5, wherein R is methyl.

8. The method of claim 4, wherein the cyclopropene compound is of the formula: 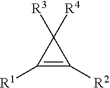
wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen.

9. The method of claim 4, wherein the cyclopropene compound comprises 1-methylcyclopropene (1-MCP).

10. The method of claim 1, wherein the predetermined period of time is at least five days.

11. A method of preserving or extending banana shelf-life or freshness during transit, comprising:
(a) contacting a banana plant before harvest of banana fruit with a composition comprising an ethylene synthesis or perception inhibitor; and
(b) harvesting the banana fruit after a predetermined period of time after step (a);
thereby preserving or extending banana shelf-life or freshness during transit in comparison to a banana plant not contacted with the composition before harvest.

12. The method of claim 11, wherein the banana shelf-life is extended at least two weeks.

13. The method of claim 11, wherein the banana plant is under stress before or during treatment of step (a).

14. The method of claim 11, wherein the ethylene synthesis or perception inhibitor comprises a cyclopropene compound or an aminovynilglycine.

15. The method according to claim 14, wherein the cyclopropene compound is of the formula: 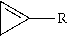
wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

16. The method of claim 15, wherein R is C₁₋₈ alkyl.

17. The method of claim 15, wherein R is methyl.

18. The method of claim 14, wherein the cyclopropene compound is of the formula: 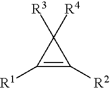
wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen.

19. The method of claim 14, wherein the cyclopropene compound comprises 1-methylcyclopropene (1-MCP).

20. The method of claim 11, wherein the predetermined period of time is at least five days.

21. A method of extending banana yellow life, comprising:
(a) contacting a banana plant before harvest of banana fruit with a composition comprising an ethylene synthesis or perception inhibitor; and
(b) harvesting the banana fruit after a first predetermined period of time after step (a); thereby extending banana yellow life in comparison to a banana plant not contacted with the composition before harvest.

22. The method of claim 21, further comprising:
(c) contacting the harvested banana with ethylene to accelerate banana ripening after a second predetermined period of time after step (b).

23. The method of claim 21, wherein the banana yellow life is extended at least five days.

24. The method of claim 21, wherein the banana plant is under stress before or during treatment of step (a).

25. The method of claim 21, wherein the ethylene synthesis or perception inhibitor comprises a cyclopropene compound or an aminovynilglycine.

26. The method according to claim 25, wherein the cyclopropene compound is of the formula: 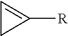
wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

27. The method of claim 26, wherein R is C₁₋₈ alkyl.

28. The method of claim 26, wherein R is methyl.

29. The method of claim 25, wherein the cyclopropene compound is of the formula: 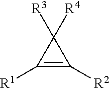
wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen.

30. The method of claim 25, wherein the cyclopropene compound comprises 1-methylcyclopropene (1-MCP).

31. The method of claim 21, wherein the first predetermined period of time is at least five days.
